(19) United States
(12) Patent Application Publication
(10) Pub. No.: US 2019/0036175 A1
(43) Pub. Date: Jan. 31, 2019

(54) Multicell Rechargeable Battery with a Dynamic Power Management System

(71) Applicant: EvansWerks, LLC, New Berlin, WI (US)

(72) Inventor: Justin Eugene EVANS, New Berlin, WI (US)

(21) Appl. No.: 15/589,791

(22) PCT Filed: Apr. 25, 2017
(86) PCT No.: PCT/IB2017/052377

§ 371 Date: May 8, 2017

Related U.S. Application Data
(60) Provisional application No. 62/325,604, filed on Apr. 21, 2016.

(51) Int. Cl. H01M 10/42; H01M 10/48; H01M 2/30; H01M 2/10

(52) U.S. Cl. CPC H01M 10/4257; H01M 10/482; H01M 2010/4271; H01M 2/1077; H01M 2/105; H01M 2/305

(57) ABSTRACT

A multicell rechargeable battery with a dynamic power management system has an enclosure, multiple cell clamps, and a power management system. The enclosure is the outer casing that holds the cell clamps in place. Each of the cell clamps is a device used to hold a single cell for the multicell battery. The enclosure has two trays that sandwich the cell clamps and keep the enclosed cells in place. Each cell clamp has a pair of endcaps and a pair of terminals. The terminals are positioned within the endcaps so that the enclosed cells can be placed into electrical communication with the power management system. The power management system dynamically modifies the circuit connection between each of the cell clamps to compensate for changes in the electrical state of the enclosed cells.

The current application is a 371 of international Patent Cooperation Treaty (PCT) application PCT/IB2017/052377, which claims a priority to a U.S. provisional application Ser. No. 62/325,604 filed on Apr. 21, 2016.

### FIELD OF THE INVENTION

The present invention relates generally to a multicell battery. More specifically, the present invention relates to a multicell battery that uses a reconfigurable circuit to modify the connections between each cell as required.

### BACKGROUND OF THE INVENTION

Batteries in present day are usually assembled using strips of conductive material, which is permanently soldered or sonically welded across the contacts of the battery's cells. This is done to create various types of series or parallel circuits. Once the conductive material is soldered or sonically welded into position, it is extremely difficult, if not impossible, to remove. The result is a rigid block of cells that now behave chemically, thermally, and electrically as a single unit. If a cell dies, the cell breaks the circuit, and the entire series is useless, even if the other cells within the series are functional. If the cell overheats, the waste heat infects nearby cells and can cause thermal runaway. Traditional multicell batteries are charged as a single unit. Traditional multicell batteries are discharged as a single unit. The assembled battery is often shrink-wrapped. Cells are often glued together to increase rigidity. These are all the reasons why lithium-ion batteries overheat, malfunction, catch on fire, explode, and prematurely die.

Therefore, an objective of the present invention is to address these shortcomings by providing an apparatus and method for a more efficient, effective, and time convenient mechanical assembly of batteries. The present invention provides a tool-less assembly which does not require soldering workstations nor sonic welding workstations. These workstations can become extremely expensive, particularly when assembling large batteries for homes, cars, trucks, trains, planes, and boats. A deep-neck sonic welding work station is extremely expensive. A battery can be assembled in a fraction of the time through the use of the present invention. The present invention is also durable with vibration-resistant rigidity. The current state of the art uses glue to create rigidity; vibration and torque cause the glue to fail. The present invention can withstand tremendous vibration and torque. The final assembly of the present invention can be easily disassembled allowing the present invention to be conveniently serviced and repaired. The current state of the art cannot be serviced or repaired. The present invention also allows individual cells to be replaced with ease.

### BRIEF DESCRIPTION OF THE DRAWINGS

FIG. 1 is a perspective view of the present invention.

FIG. 2 is a perspective view of the first tray for the present invention.

FIG. 3 is a perspective view of the second tray for the present invention.

FIG. 4 is a schematic view of the power management system used in the present invention where dotted lines indicate electronic connectivity and solid bold lines indicate electrical connectivity.

FIG. 5 is a schematic view of the connections between the power management system, the arbitrary clamp, and at least one other clamp used in the present invention, wherein dotted lines indicate electronic connectivity and solid bold lines indicate electrical connectivity.

FIG. 6 is a schematic view of the connections between the microcontroller and the plurality of sensor suites used in the present invention, wherein each of the plurality of sensor suites is operatively coupled to the corresponding clamp.

FIG. 7 is a schematic view of the connections between the microcontroller, the corresponding clamp, and each of the sensors from the sensor suite used in the present invention, wherein dotted lines indicate electronic connectivity and solid bold lines indicate electrical connectivity.

### DETAIL DESCRIPTIONS OF THE INVENTION

All illustrations of the drawings are for the purpose of describing selected versions of the present invention and are not intended to limit the scope of the present invention.

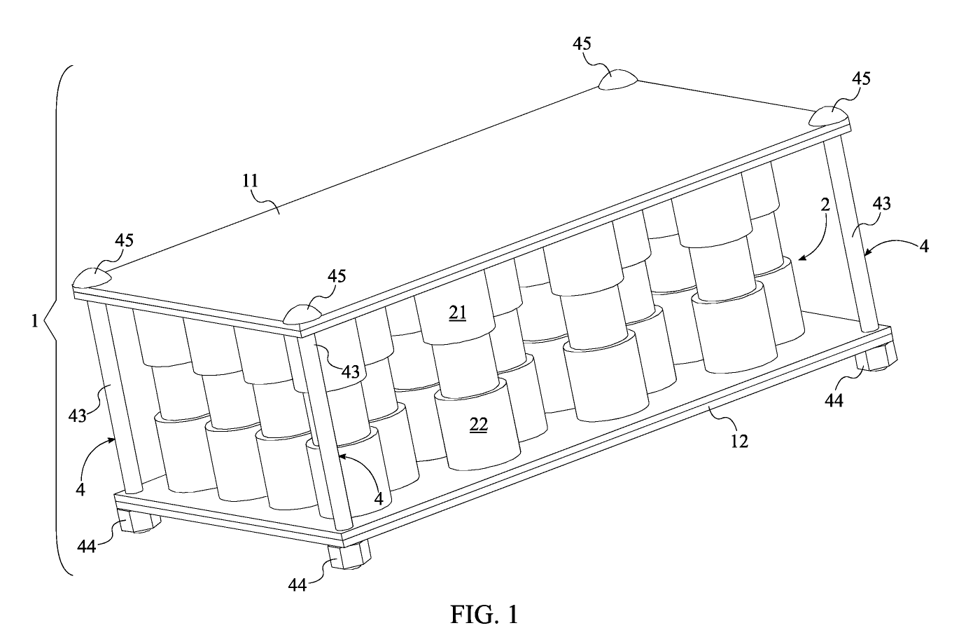

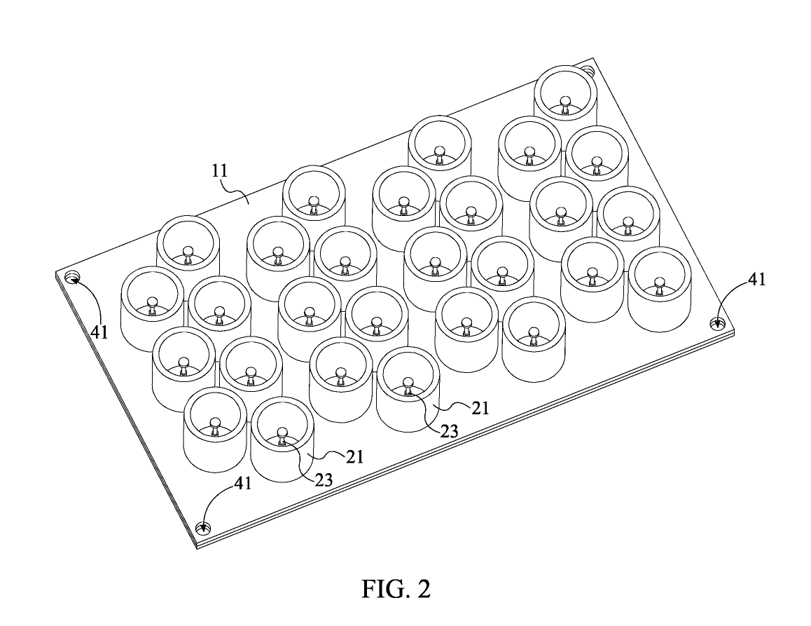

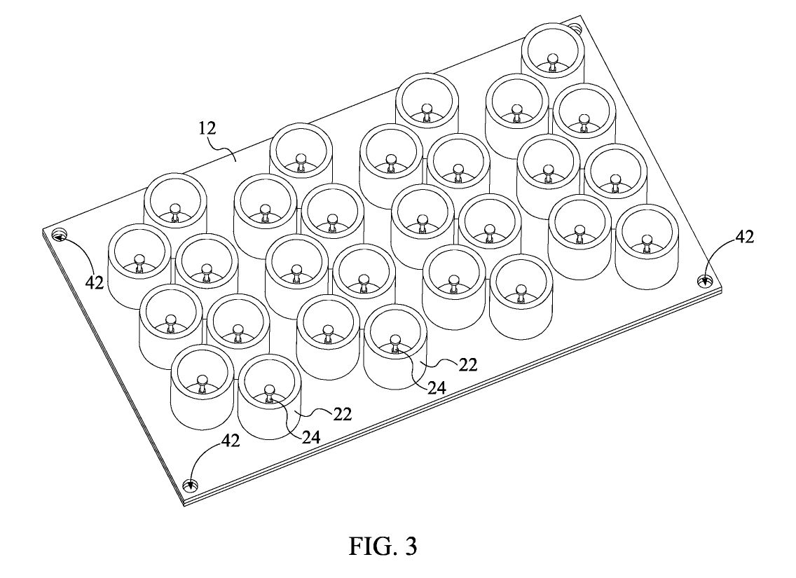

As can be seen in FIG. 1 through FIG. 7, the preferred embodiment of the present invention, the multicell rechargeable battery with a dynamic power management system, is a device that enables the efficient power management of a plurality of rechargeable battery cells. The present invention is a device that uses a reconfigurable circuit system to enable granular control of a battery system with multiple cells. That is, the present invention is a system that monitors the electrical state and the environmental conditions around each individual cell of a multicell battery. This granular control is used to shut off the flow of current to and from battery cells that are damaged, at risk of overcharging and at risk of over-discharging. Additionally, the present invention is able to modify the circuit connection between each cell, such that the cells can be transitioned between parallel and series connections in response to instructions from the dynamic power management system.

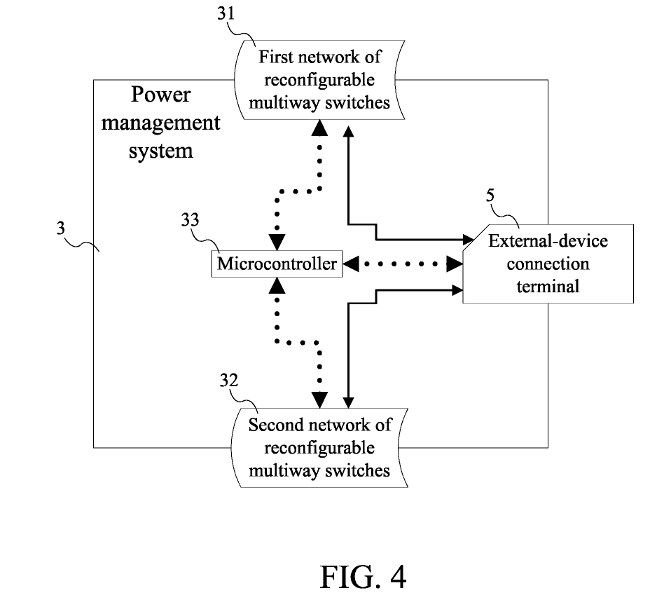

As can be seen in FIG. 1 and FIG. 4, the present invention functions as a multicell battery with individual cells that can be easily replaced. To accomplish this, the present invention comprises an enclosure 1, a plurality of cell clamps 2, and a power management system 3. The enclosure 1 functions as the housing that acts as the structural foundation for the other components of the present invention. The overall shape of the present invention is also defined by the enclosure. The enclosure 1 comprises a first tray 11 and a second tray 12. The first tray 11 and the second tray 12 are rigid panels that are used to hold the plurality of cell clamps 2 and the power management system 3 in desired positions and orientations. The plurality of cell clamps 2 is the collection of components that retain the multiple cells of the multicell battery in electrical communication with the power management system 3. To that end, each of the plurality of cell clamps 2 comprises a first endcap 21, a second endcap 22, a first terminal 23, and a second terminal 24. The plurality of cell clamps 2 is distributed throughout the enclosure 1 so that the present invention is able to hold a plurality of battery cells within the enclosure 1. Furthermore, the plurality of cell clamps 2 is positioned in between the first tray 11 and the second tray 12. Consequently, each clamp from the plurality of cell clamps 2 is used to sandwich an inserted battery cell between the first tray 11 and the second tray 12.

As can be seen in FIG. 1 through FIG. 5, in the preferred embodiment of the present invention, each clamp from the plurality of cell clamps 2 is used to hold a single inserted battery cell. The first endcap 21 functions as the first jaw for each clamp from the plurality of cell clamps 2. Additionally, the first endcap 21 is mounted onto the first tray 11. As a result, the first endcap 22 is able to retain a first end of the inserted battery cell in a fixed position. The first terminal 23 is mounted within the first endcap 21. Thus positioned, the first terminal 23 is able to maintain the first end of the inserted battery cell in electrical communication with the power management system 3. Likewise, the second endcap 22 is mounted onto the second tray 12. Accordingly, the second endcap 22 functions as the second jaw of the clamp from the plurality of cell clamps 2 that retains a second end of the inserted battery cell in a fixed position. The second terminal 24 is mounted within the second endcap 22 so that the second end of the inserted battery cell is maintained in electrical communication with the power management system 3. In the present invention, the first endcap 21 is concentrically aligned with the second endcap 22. Consequently, the first endcap 21 and the second endcap 22 are able to function as receptacles for the ends of an elongated battery cell. The first terminal 23 and the second terminal 24 are preferably spring contact terminals. Both the first terminal 23 and the second terminal 24 are able to extend and contract if the inserted battery cell is jostled between the first tray 11 and the second tray 12. This ability to extend and contract enables the first terminal 23 and the second terminal 24 to maintain a constant electrical connection with the positive and negative terminals of the inserted battery cell while the clamp from the plurality of cell clamps 2 is clamped around the inserted battery cell.

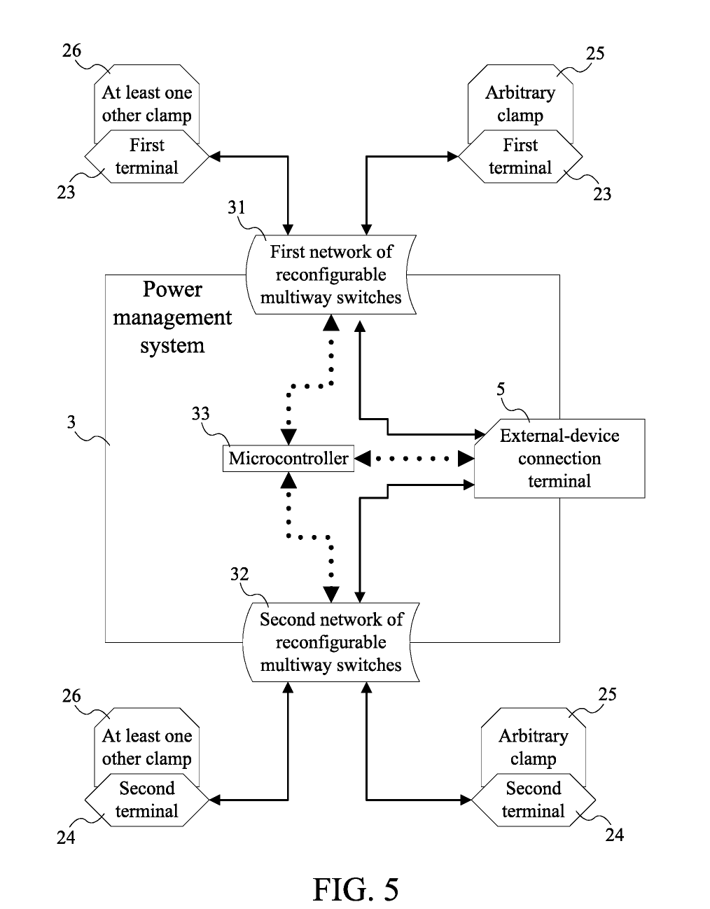

As can be seen in FIG. 1 and FIG. 5, the first terminal 23 and the second terminal 24 form the electrical connectors that enable the inserted battery cell to be electrically connected to the power management system 3. The power management system 3 is a collection of electrical components that monitor each clamp from the plurality of cell clamps 2 to assess the operational capacity of the inserted battery cell. To that end, the power management system 3 is integrated into the enclosure 1. Additionally, the first terminal 23 and the second terminal 24 for each of the plurality of cell clamps 2 is electrically connected to the power management system 3. As a result, the power management system 3 is able to govern the operation of each of the plurality of cell clamps 2.

As can be seen in FIG. 1 and FIG. 5, to govern the operation of the plurality of cell clamps 2, the power management system 3 comprises a first network of reconfigurable multiway switches 31, a second network of reconfigurable multiway switches 32, and a microcontroller 33. The first network of reconfigurable multiway switches 31 and the second network of reconfigurable multiway switches 32 are circuits that can be dynamically modified to change the electrical connections between attached components. To make use of this functionality, the first terminal 23 of an arbitrary clamp 25 is electrically connected to the first terminal 23 of at least one other clamp 26 through the first network of reconfigurable multiway switches 31, wherein the arbitrary clamp 25 and the at least one other clamp 26 are from the plurality of cell clamps 2. Similarly, the second terminal 24 of the arbitrary clamp 25 is electrically connected to the second terminal 24 of the at least one other clamp 26 through the second network of reconfigurable multiway switches 32. Thus connected, the present invention is able to reconfigure the electrical circuit that connects each of the plurality of cell clamps 2 to the power management system 3. For example, if an inserted battery cell in the arbitrary clamp 25 is defective, the first network of reconfigurable multiway switches 31 and the second network of reconfigurable multiway switches 32 can be directed to open the circuit between the defective inserted battery cell and the remaining inserted battery cells. The microcontroller is used to manage the computerized commands of the present invention. To accomplish this circuit reconfiguration, the first network of reconfigurable multiway switches 31 and the second network of reconfigurable multiway switches 32 are electronically connected to the microcontroller 33. Accordingly, the microcontroller 33 dictates how the first network of reconfigurable multiway switches 31 and the second network of reconfigurable multiway switches 32 form connections between the plurality of cell clamps 2.

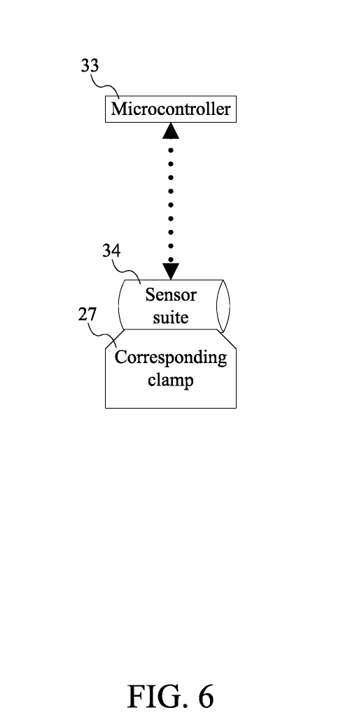

As can be seen in FIG. 1 and FIG. 6, the present invention is able to accurately assess the operational capacity of the plurality of cell clamps 2 because the power management system 3 further comprises a plurality of sensor suites 34. Each of the plurality of sensor suites 34 is a collection of environmental and electrical sensors that are used to detect conditions that include, but are not limited to, voltage, current, temperature, resistance, wattage, and impedance. In the present invention, each of the plurality of sensor suites 34 is operatively coupled to a corresponding clamp 27 from the plurality of cell clamps 2, wherein each of the plurality of sensor suites 34 is used to gather environmental data on the corresponding clamp 27. Consequently, each of the plurality of sensor suites 34 is able to collect data that determines if the power management system 3 should modify the connection or flow of current to the corresponding clamp 27. This is possible because each of the plurality of sensor suites 34 is electronically connected to the microcontroller 33. As a result, the microcontroller 33 is able to interpret the data gathered by the plurality of sensor suites 34 and issue reconfiguration commands to the first network of reconfigurable multiway switches 31 and the second network of reconfigurable multiway switches 32. These reconfiguration commands should be able to mitigate any operational issues that arise from any individual battery cell.

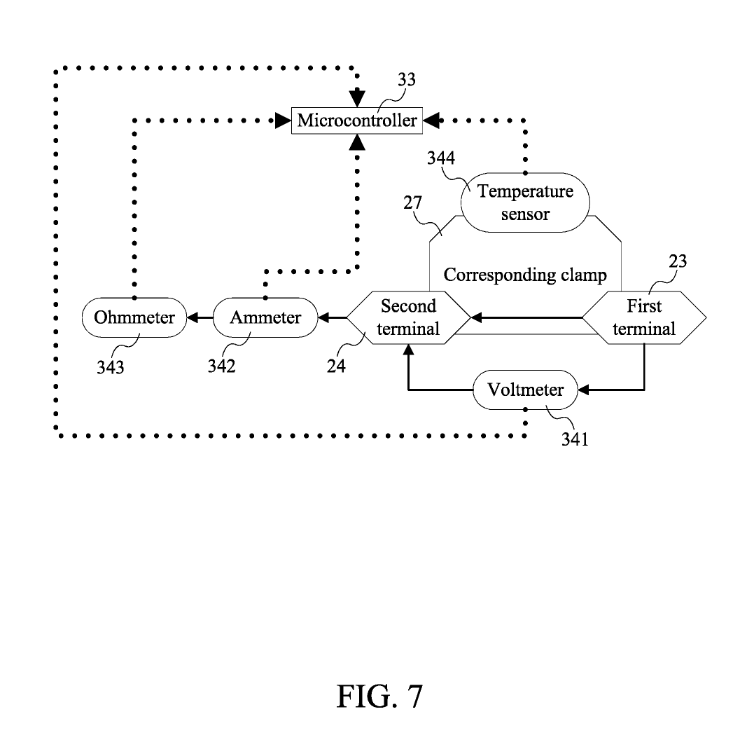

As can be seen in FIG. 1 and FIG. 7, each of the plurality of sensor suites 34 uses various types of sensors to assess the operational capacity of the inserted battery cell and the corresponding clamp 27. To that end, each of the plurality of sensor suites 34 may comprise a voltmeter 341, an ammeter 342, an ohmmeter 343, a temperature sensor 344 or a combination thereof. The voltmeter 341 is electrically connected in parallel between the first terminal 23 and the second terminal 24 so that the voltmeter 341 is able to measure the voltage between the first terminal 23 and the second terminal 24. The ammeter 342 is electrically connected in series with the first terminal 23 and the second terminal 24. Thus connected, the ammeter 342 is able to determine the current flowing through the first terminal 23 and the second terminal 24. The ohmmeter 343 is electrically connected in series with the first terminal 23 and the second terminal 24. Accordingly, the ohmmeter 343 is able to determine the resistance of the first terminal 23 and the second terminal 24. Finally, the temperature sensor 344 is in thermal communication with the first endcap 21 and the second endcap 22 so that the temperature sensor 344 is able to determine the temperature of the corresponding clamp 27.

As can be seen in FIG. 1 and FIG. 4, a primary purpose of the present invention is to provide a multicell battery with cells that are both easy to replace, yet remain in electrical communication with the plurality of cell clamps 2 when the enclosure 1 is violently shaken. To accomplish this, the present invention comprises a plurality of displacement limiting mechanisms 4. Each of the plurality of displacement limiting mechanisms 4 is a device that prevents the first tray 11 and the second tray 12 from moving farther than a predetermined distance away from each other. Each of the plurality of displacement limiting mechanisms 4 is preferably a mechanical fastener that prevents lateral displacement of the first tray 11 relative to the second tray 12. In the preferred embodiment of the present invention, the first tray 11 and the second tray 12 are positioned parallel to and offset from each other. Consequently, the plurality of cell clamps 2 is sandwiched between the first tray 11 and the second tray 12. The plurality of displacement limiting mechanisms 4 is peripherally distributed within the enclosure 1. As a result, the plurality of displacement limiting mechanisms 4 forms a support structure around the plurality of cell clamps 2 that maintains the first tray 11 and the second tray 12 in positions which prevent the inserted battery cells from becoming disconnected from the power management system 3. The plurality of displacement limiting mechanisms 4 is detachably attached in between the first tray 11 and the second tray 12. Thus positioned, the plurality of displacement limiting mechanisms 4 facilitates replacing and repairing the inserted battery cells by enabling a user to easily remove the first tray 11 and access the inserted battery cells held by the plurality of cell clamps 2.

As can be seen in FIG. 1, to expound on the descriptions of the plurality of displacement limiting mechanisms 4, each of the plurality of displacement limiting mechanisms 4 comprises a first hole 41, a second hole 42, a bolt 43, and a nut 44. The first hole 41 traverses through the first tray 11, and the second hole 42 traverses through the second tray 12. Accordingly, the first hole 41 and the second hole 42 form the connection points that the bolt 43 uses to become attached to the first tray 11 and the second tray 12. To accomplish this, the bolt 43 is positioned through the first hole 41 and the second hole 42. A head 45 of the bolt 43 is positioned adjacent to the first tray 11, opposite to the plurality of cell clamps 2 so that the head 45 of the bolt 43 limits the distance that the bolt 43 is able to travel through the first tray 11. The nut 44 is positioned adjacent to the second tray 12, opposite to the plurality of cell clamps 2, and the bolt 43 engages the nut 44. Consequently, the nut 44 is able to prevent the second tray 12 from moving farther than a desired distance away from the first tray 11.

As can be seen in FIG. 1 and FIG. 4, the present invention is designed to function as a rechargeable battery system that can be charged by an external power supply, and then discharged into an external load. To accomplish this, the present invention comprises an external-device connection terminal 5. The external-device connection terminal 5 is an electrical terminal that enables the present invention to become electrically connected to an external device. The external-device connection terminal 5 is electrically connected to the power management system 3. As a result, electrical power that is delivered to the external-device connection terminal 5 can be distributed to the plurality of cell clamps 2. Additionally, the plurality of cell clamps 2 is able to supply power to an external device through the power management system 3 and the external-device connection terminal 5.

Although the invention has been explained in relation to its preferred embodiment, it is to be understood that many other possible modifications and variations can be made without departing from the spirit and scope of the invention as hereinafter claimed.

What is claimed is:

1. A multicell rechargeable battery with a dynamic power management system comprises:
an enclosure;
a plurality of cell clamps;
a power management system;
the enclosure comprises a first tray and a second tray;
each of the plurality of cell clamps comprises a first endcap, a second endcap, a first terminal, and a second terminal;
the plurality of cell clamps being distributed throughout the enclosure;
the plurality of cell clamps being positioned in between the first tray and the second tray;
the first endcap being mounted onto the first tray;
the first terminal being mounted within the first endcap;
the second endcap being mounted onto the second tray;
the second terminal being mounted within the second endcap;
the first endcap being concentrically aligned with the second endcap;
the power management system being integrated into the enclosure; and
the first terminal and the second terminal for each of the plurality of cell clamps being electrically connected to the power management system.

2. The multicell rechargeable battery with a dynamic power management system as claimed in claim 1 comprises:
the power management system comprises a first network of reconfigurable multiway switches, a second network of reconfigurable multiway switches, and a microcontroller;
the first terminal of an arbitrary clamp being electrically connected to the first terminal of at least one other clamp through the first network of reconfigurable multiway switches, wherein the arbitrary clamp and the at least one other clamp are from the plurality of cell clamps;
the second terminal of the arbitrary clamp being electrically connected to the second terminal of the at least one other clamp through the second network of reconfigurable multiway switches; and
the first network of reconfigurable multiway switches and the second network of reconfigurable multiway switches being electronically connected to the microcontroller.

3. The multicell rechargeable battery with a dynamic power management system as claimed in claim 1 comprises:
the power management system further comprises a plurality of sensor suites and a microcontroller;
each of the plurality of sensor suites being operatively coupled to a corresponding clamp from the plurality of cell clamps, wherein each of the plurality of sensor suites is used to gather environmental data on the corresponding clamp; and
each of the plurality of sensor suites being electronically connected to the microcontroller.

4. The multicell rechargeable battery with a dynamic power management system as claimed in claim 3 comprises:
each of the plurality of sensor suites comprises a voltmeter; and
the voltmeter being electrically connected in parallel between the first terminal and the second terminal.

5. The multicell rechargeable battery with a dynamic power management system as claimed in claim 3 comprises:
each of the plurality of sensor suites comprises an ammeter; and
the ammeter being electrically connected in series with the first terminal and the second terminal.

6. The multicell rechargeable battery with a dynamic power management system as claimed in claim 3 comprises:
each of the plurality of sensor suites comprises an ohmmeter; and
the ohmmeter being electrically connected in series with the first terminal and the second terminal.

7. The multicell rechargeable battery with a dynamic power management system as claimed in claim 3 comprises:
each of the plurality of sensor suites comprises a temperature sensor; and
the temperature sensor being in thermal communication with the first endcap and the second endcap.

8. The multicell rechargeable battery with a dynamic power management system as claimed in claim 1 comprises:
a plurality of displacement limiting mechanisms;
the first tray and the second tray being positioned parallel to and offset from each other;
the plurality of displacement limiting mechanisms being peripherally distributed within the enclosure; and
the plurality of displacement limiting mechanisms being detachably attached in between the first tray and the second tray.

9. The multicell rechargeable battery with a dynamic power management system as claimed in claim 2 comprises:
each of the plurality of displacement limiting mechanisms comprises a first hole, a second hole, a bolt, and a nut;
the first hole traversing through the first tray;
the second hole traversing through the second tray;
the bolt being positioned through the first hole and the second hole;
a head of the bolt being positioned adjacent to the first tray, opposite to the plurality of cell clamps;
the nut being positioned adjacent to the second tray, opposite to the plurality of cell clamps; and
the bolt engaging the nut.

10. The multicell rechargeable battery with a dynamic power management system as claimed in claim 1, wherein the first terminal and the second terminal are spring contact terminals.

11. The multicell rechargeable battery with a dynamic power management system as claimed in claim 1 comprises:
an external-device connection terminal; and
the external-device connection terminal being electrically connected to the power management system.

12. A multicell rechargeable battery with a dynamic power management system comprises:
an enclosure;
a plurality of cell clamps;
a power management system;
the enclosure comprises a first tray and a second tray;
each of the plurality of cell clamps comprises a first endcap, a second endcap, a first terminal, and a second terminal;
the power management system comprises a first network of reconfigurable multiway switches, a second network of reconfigurable multiway switches, and a microcontroller, a plurality of sensor suites and a microcontroller;
the plurality of cell clamps being distributed throughout the enclosure;
the plurality of cell clamps being positioned in between the first tray and the second tray;
the first endcap being mounted onto the first tray;
the first terminal being mounted within the first endcap;
the second endcap being mounted onto the second tray;
the second terminal being mounted within the second endcap;
the first endcap being concentrically aligned with the second endcap;
the power management system being integrated into the enclosure;
the first terminal and the second terminal for each of the plurality of cell clamps being electrically connected to the power management system;
the first terminal of an arbitrary clamp being electrically connected to the first terminal of at least one other clamp through the first network of reconfigurable multiway switches, wherein the arbitrary clamp and the at least one other clamp are from the plurality of cell clamps;
the second terminal of the arbitrary clamp being electrically connected to the second terminal of the at least one other clamp through the second network of reconfigurable multiway switches;
the first network of reconfigurable multiway switches and the second network of reconfigurable multiway switches being electronically connected to the microcontroller;
each of the plurality of sensor suites being operatively coupled to a corresponding clamp from the plurality of cell clamps, wherein each of the plurality of sensor suites is used to gather environmental data on the corresponding clamp; and
each of the plurality of sensor suites being electronically connected to the microcontroller.

13. The multicell rechargeable battery with a dynamic power management system as claimed in claim 12 comprises:
each of the plurality of sensor suites comprises a voltmeter; and
the voltmeter being electrically connected in parallel between the first terminal and the second terminal.

14. The multicell rechargeable battery with a dynamic power management system as claimed in claim 12 comprises:
each of the plurality of sensor suites comprises an ammeter; and
the ammeter being electrically connected in series with the first terminal and the second terminal.

15. The multicell rechargeable battery with a dynamic power management system as claimed in claim 12 comprises:
each of the plurality of sensor suites comprises an ohmmeter; and
the ohmmeter being electrically connected in series with the first terminal and the second terminal.

16. The multicell rechargeable battery with a dynamic power management system as claimed in claim 12 comprises:
each of the plurality of sensor suites comprises a temperature sensor; and
the temperature sensor being in thermal communication with the first endcap and the second endcap.

17. The multicell rechargeable battery with a dynamic power management system as claimed in claim 12 comprises:
a plurality of displacement limiting mechanisms;
the first tray and the second tray being positioned parallel to and offset from each other;
the plurality of displacement limiting mechanisms being peripherally distributed within the enclosure; and
the plurality of displacement limiting mechanisms being detachably attached in between the first tray and the second tray.

18. The multicell rechargeable battery with a dynamic power management system as claimed in claim 17 comprises:
each of the plurality of displacement limiting mechanisms comprises a first hole, a second hole, a bolt, and a nut;
the first hole traversing through the first tray;
the second hole traversing through the second tray;
the bolt being positioned through the first hole and the second hole;
a head of the bolt being positioned adjacent to the first tray, opposite to the plurality of cell clamps;
the nut being positioned adjacent to the second tray, opposite to the plurality of cell clamps; and
the bolt engaging the nut.

19. The multicell rechargeable battery with a dynamic power management system as claimed in claim 12, wherein the first terminal and the second terminal are spring contact terminals.

20. The multicell rechargeable battery with a dynamic power management system as claimed in claim 12 comprises:
an external-device connection terminal; and
the external-device connection terminal being electrically connected to the power management system.
